(19) United States
(12) Patent Application Publication
(10) Pub. No.: US 2026/0058392 A1
(43) Pub. Date: Feb. 26, 2026

(54) BATTERY INTERFACE FOR PORTABLE RADIO

(71) Applicant: MOTOROLA SOLUTIONS, INC., CHICAGO, IL (US)

(72) Inventor: ARUN KRISHNAN, HILBERT (AU)

(21) Appl. No.: 18/814,665

(22) Filed: Aug. 26, 2024

(51) Int. Cl. H01R 13/24; H01R 13/625; H01R 13/627; H01R 13/629

(52) U.S. Cl. CPC H01R 13/2421; H01R 13/2471; H01R 13/625; H01R 13/6275; H01R 13/62927; H01R 2201/24

(57) ABSTRACT

A ground contact spring plate (108) for a battery interface (102) of a portable radio (100) is provided. The ground contact spring plate (108) is formed of a unitary sheet metal piece part having a top surface (108a) and a bottom surface (108b), a center aperture (108c) formed through the top surface and bottom surface, and first and second finger spring contacts (108d, 108e)) integrally formed along first and second side edges (108f, 108g) of the ground contact spring plate (108).

### BACKGROUND

First responders, emergency service personnel, and/or military personnel often carry battery operated portable radios. Such portable radio products are often operated under high impact conditions which may subject the products to vibration and drop. It is highly desirable to maintain stable power operation of the portable radio under various use case conditions, including conditions where vibration and drop are more likely to occur.

### BRIEF DESCRIPTION OF THE DRAWINGS

FIG. 1 shows a partial view of a portable radio with a battery interface 102 and a battery with a radio interface, in accordance with some embodiments.

FIG. 2 shows an exploded view of the battery interface assembly of the portable radio, in accordance with some embodiments.

FIG. 3 shows the rotational twist attachment of the battery to the portable radio having the battery interface and partial cross-sectional views of engagement formed in accordance with some embodiments.

FIG. 4 shows a full view of the portable radio with battery interface coupled to the battery, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The assembly, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Operation of battery operated portable radios may take place under rugged conditions, including vibration and drop conditions. Under such conditions, the impact may result in intermittent disruption in the power supply to the radio, leading to a voltage drop and abnormal behavior of the radio, such as hanging and rebooting. It is highly desirable to maintain stable power operation under various customer use cases, including normal everyday use as well as ruggedized usage, such as combat situations, where vibration and drop are more likely to occur.

One cause of the intermittent power problem is the use of third party batteries. These third party batteries may include battery lock plates on the battery side which act as a ground contact, and which are fitted to a plastic body. Under high impact scenarios, the lock plates may move up and down due to the flexibility of the plastic. The up/down movement can affect the ground contact between the battery and the portable radio.

Accordingly, there is a need for an improved interface between the portable radio and the battery, while still allowing for the use of third party off-the shelf batteries.

The embodiments provided herein provide for a ground contact spring plate for a battery interface of a portable radio. The embodiments further provide for an assembly which incorporates the ground contact spring plate into the battery interface of a portable radio. The embodiments provided herein further provide for a portable radio incorporating the battery interface including the ground contact spring plate coupled to a battery having a radio interface.

The Table below provides a list of reference numerals to facilitate review.

| | |
|---|---|
| 100 | portable radio |
| 101 | portable radio housing |
| 102 | battery interface |
| 104 | battery lock plate |
| 104a | upper lock plate surface |
| 104b | lower lock plate surface |
| 104c | aperture of the battery lock plate |
| 104d | first side tab |
| 104e | second side tab |
| 104f | first tapered surface of lower lock plate surface |
| 104g | second tapered surface of lower lock plate surface |
| 105 | o-ring |
| 106 | battery connector, |
| 106a | top surface of battery connector |
| 106b | bottom surface of battery connector |
| 106c | pogo pins |
| 106d | tail pins of the pogo pins |
| 106e | electronic flex |
| 107 | o-ring |
| 108 | ground contact spring plate |
| 108a | top surface of ground contact spring plate |
| 108b | bottom surface of ground contact spring plate |
| 108c | center aperture of ground contact spring plate |
| 108d | first finger spring contact |
| 108e | second finger spring contact |
| 108f | first side edge |
| 108g | Second side edge |
| 108h | first raised portion (of first finger spring contact) |
| 108i | second raised portion (of second finger spring contact) |
| 108j, | first predetermined gap |
| 108k | second predetermined gap |
| 110a | first screw |
| 110b | second screw |
| 112a | first screw holes |
| 112b | second screw holes |
| 114a | first screw mount |
| 114b | second screw mount |
| 116 | circular opening of portable housing |
| 118a | first guide rail |
| 118b | second guide rail |
| 118c | first raised alignment tab |
| 118d | second raised alignment tab |
| 120 | side locking arm |
| 200 | battery |
| 201 | battery housing |
| 202 | radio interface |
| 204 | planar contacts (B+, Data, B+) of the battery |
| 206a | first battery ground (GND) plate |
| 206b | second battery ground (GND) plates |
| 208 | charging contacts |
| 310 | first view |
| 312 | cross-sectional side view (without battery) |
| 314 | two half round tabs of battery lock plate |
| 320 | second view |
| 330 | third view |
| 332 | cross-sectional side view (with battery attached) |

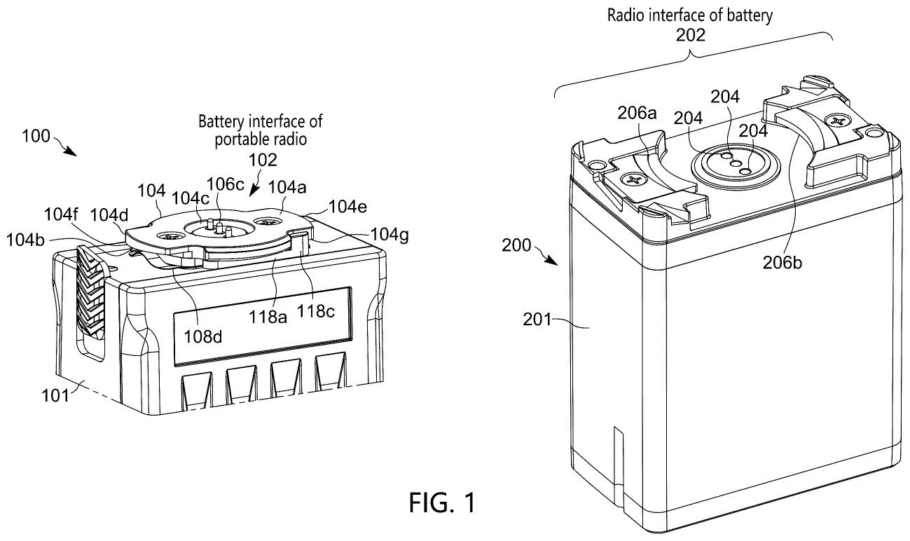

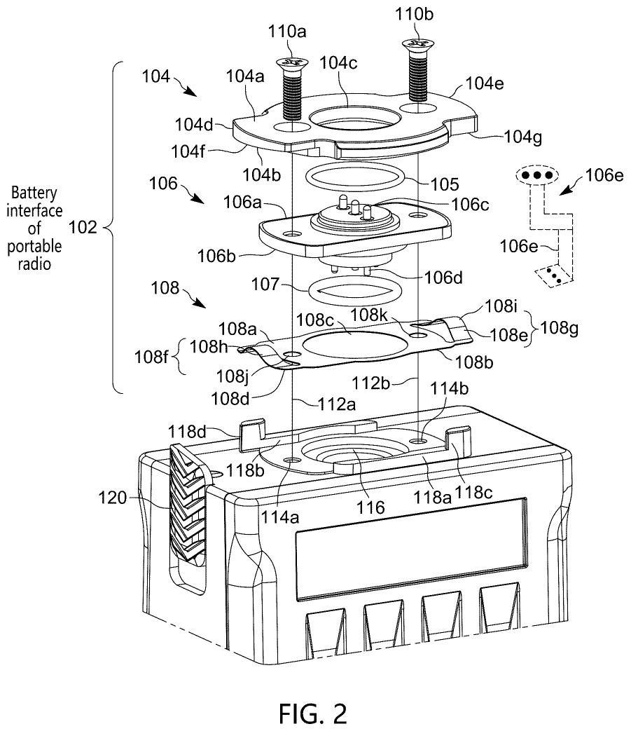

FIG. 1 shows a partial view of a portable radio 100 with a battery interface 102 and a battery 200 with a radio interface 202, in accordance with some embodiments. FIG. 2 shows an exploded view of the battery interface assembly 102 of the portable radio 100, in accordance with some embodiments.

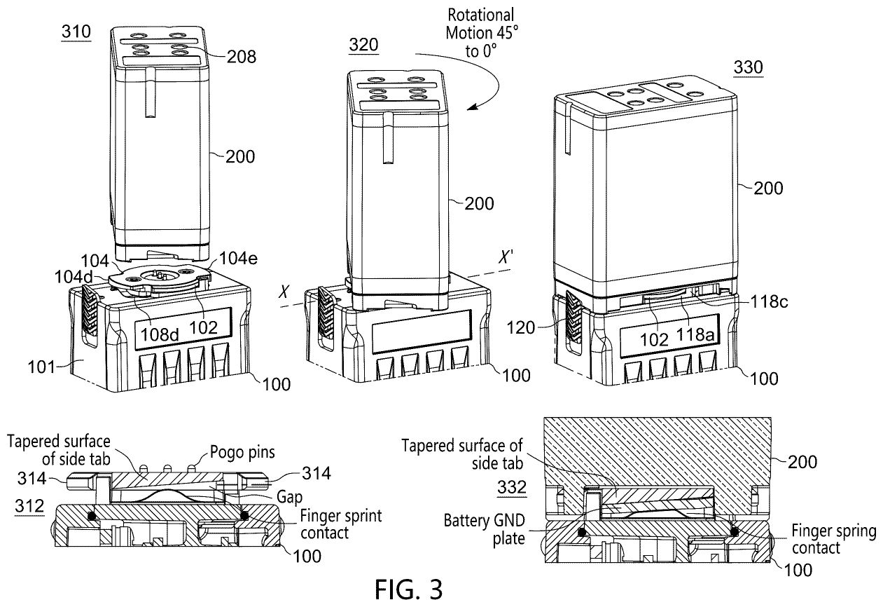

Referring to FIG. 1, the portable radio 100 comprises a radio housing 101 having a top surface upon which an assembled view of the battery interface 102 is located. This view shows the battery interface 102 comprising a battery lock plate 104 having upper and lower lock plate surfaces 104a, 104b with an aperture 104c and first and second side tabs 104d, 104c extending therefrom. The first and second side tabs 104d, 104c have respective first and second tapered surfaces 104f, 104g on the lower lock plate surface 104b. In this view, pogo pins 106c are shown to extend through the aperture 104c. Additional elements of the battery interface 102 are described later in conjunction with the exploded view of FIG. 2 and views of FIG. 3.

FIG. 1 further shows the battery 200 having the radio interface 202 for coupling to the assembled battery interface 102 of the portable radio 100. The battery 200 comprises a battery housing 201, formed of a plastic body. A radio interface 202 is located upon a top surface of the battery housing and comprises a plurality of planar contacts 206 (B+, data, B+) situated between first and second battery ground plates 206a, 206b. Charger contacts (shown later in FIG. 3) are located on a bottom surface of the battery housing (shown later in FIG. 3). The battery ground plates 206a, 206b have ramped surfaces. When the radio interface 202 couples to the battery interface 102 (via a twist/rotate action), the ramped surfaces of the ground plates 206a, 206b engage to the radio interface (as will be shown in FIG. 3), and the planar contacts 204 of the battery 200 align and mate with the pogo pins 106c that extend through the aperture 104c of the battery lock plate 104.

Referring to the exploded view of FIG. 2, beneath the battery lock plate 104, the battery interface 102 further comprises a battery connector 106. The battery connector 106 is formed of a molded plastic part having top and bottom surfaces 106a, 106b and may further comprise an interior copper plate (not shown). The battery connector 106 comprises pogo pins 106c having tail ends 106d. The pogo pins 106c protrude from the top surface 106a of the battery connector and, as previously mentioned, extend into the aperture 104c of the of the battery lock plate 104. The pogo pins 106c are spring-loaded pins having a moving plunger that extend through the aperture 104c of the battery lock plate 104. The tail ends 106d of the pogo pins 106c are fixed. The tail ends protrude through the bottom surface 106b of the battery connector 106 and extend through a center aperture 108c of a ground contact spring plate 108 (described later).

Referring to the exploded view of FIG. 2, the battery interface 102 may further comprise an o-ring 105 to surround the pogo pins 106c. The battery interface 102 may further comprise another o-ring 107 to surround the tail ends 106d of the pogo pins 106c.

In accordance with the embodiments and referring to FIGS. 1 and 2, the battery interface 102 of the portable radio 100 further comprises a ground contact spring plate 108. The ground contact spring plate 108 is formed of a rectangular shaped, unitary sheet metal piece part having respective top and bottom surfaces 108a, 108b and a center aperture 108c formed through the top and bottom surfaces. In accordance with some embodiments, a first finger spring contact 108d is integrally formed along a first side edge 108f of the ground contact spring plate 108, and a second finger spring contact 108e is integrally formed along a second side edge 108g of the ground contact spring plate.

As mentioned previously, the tail ends 106d of the pogo pins 106c of the battery connector 106 extend through the center aperture 108c of the ground contact spring plate 108. The tail ends 106d are soldered to an electronic flex 106e (shown in dashed lines) which extends through the center aperture 108c to couple to corresponding power contacts (not shown) disposed on a printed circuit board (PCB) recessed within a circular opening 116 of the portable radio 100.

As shown in FIG. 2, the first finger spring contact 108d has a first raised portion 108h, relative to the top surface 108a of the ground contact spring plate 108. As further shown in FIG. 2, the second finger spring contact 108e has a second raised portion 108i relative to the top surface 108a of the ground contact spring plate 108. The first and second finger spring contacts 108d, 108e with respective first and second raised portions 108h, 108i are located diagonally opposite each other on the ground contact spring plate 108. The first and second raised portions 108h, 108i provide opposing ramps upon which to respectively engage the first and second battery ground plates 206a, 206b (shown in FIG. 1).

The assembly of radio interface 102 is achieved through screws 110a, 110b inserted through aligned and corresponding screw holes 112a, 112b, the screw holes being present on each of the battery lock plate 104, battery connector 106, and the ground contact spring plate 108. For example, referring to the ground contact spring plate 108 of FIG. 2, the first and second screw holes 112a, 112b are formed through the top and bottom surfaces 108a, 108b of the ground contact spring plate 108, the first screw hole 112a being located between the center aperture 108c and the first finger spring contact 108e, and the second screw hole 112b being formed between the aperture 108c and the second finger spring contact 108e. The screws 112a, 112b of the assembly are threaded into screw mounts 114a, 114b of the portable radio 100. The screw holes and screws facilitate assembly of the ground contact spring plate 108 to the battery lock plate 104 and the battery connector 106 of the battery interface 102 of the portable radio. For example, the battery lock plate 104, battery connector 106, and ground contact spring plate 108 may be coupled via first and second screws 110a, 110b to a paint-free zone of the portable radio.

When the battery interface 102 is assembled, the first and second raised portions 108h, 108i. of the first and second finger spring contacts 108d, 108e form respective first and second predetermined gaps 108j, 108k beneath the first and second tapered surfaces 104f, 104g of the first and second side tabs 104d, 104e of the battery lock plate 104. The predetermined gap (108j or 108k) is shown in a side cross-section view 312 at FIG. 3. The first and second raised portions 108h, 108i of the first and second spring contacts 108d, 108e do not touch the lower lock plate surface 104b. The first and second predetermined gaps 108j, 108k are formed to accommodate receiving first and second battery ground plates 206a, 206b during rotational attachment of the battery 200. As the raised portions 108h, 108i of the of the first and second finger spring contacts 108d, 108e are diagonally opposite to each other, so too are the opposed ramps of the first and second finger spring contacts 108d, 108e and the first and second predetermined gaps 108j, 108k diagonally opposite to each other.

The unitary sheet metal piece part forming the ground contact spring plate 108 may have a planar thickness ranging between, for example, 0.12 millimeters and 0.18 millimeters. The first and second raised portions of the diagonally opposed first and second finger spring contacts 108d, 108e may have a height ranging between 2.1 millimeters and 2.5 millimeters relative to the bottom surface 108b of the unitary sheet metal piece part. The first and second predetermined gaps 108j, 108k of the first and second finger spring contacts 108d, 108e relative to the lower lock plate surface 104b may have a height ranging between 0.5 millimeters and 1.5 millimeters.

In accordance with some embodiments, the battery 200 is attached to the portable radio 100 via a cam action which rotates/twists the battery at a predetermined angle (approximate 45 degree twist) to secure the battery 200 to the portable radio 100. During attachment, the first and second battery ground plates 206a, 206b fill up the first and second predetermined gaps 108j, 108k and also slide up the finger spring contacts 108d, 108e to the raised portions 108h, 108i. The bottom ramped surfaces of the first and second battery ground plates 206a, 206b respectively make contact with the first and second tapered surfaces 104f, 104g of the first and second side tabs 104d, 104e of the lower lock plate surface 104b.

The primary ground contact is established by the connection between the bottom surface (lower lock plate surface 104b) of the battery lock plate 104 of the portable radio 100 and the bottom surface(s) of the battery ground plates 206a, 206b on the battery 200. However, the battery ground plate(s) 206a, 206b are mounted on the plastic body of the battery 200, which may cause the battery ground plate(s) 206a, 206b to move during high impact situations, resulting in intermittent disconnection of the battery lock plate 104.

In accordance with the embodiments, the raised portions 108h, 108i of the finger spring contacts 108d, 108e are compressed against the top surfaces of the battery ground plates 206a, 206b (when the battery is attached to the radio). The finger spring contacts 108d, 108e will accommodate the vertical movement of the battery ground plate(s) 206a, 206b under high impact scenarios. The raised portion(s) 108h, 108i of the of the finger spring contact(s) s 108d, 108e flex to maintain contact with the battery ground plates 206a, 206b, thereby ensuring that ground contact is maintained even when the primary contact between the battery lock plate 104 and the battery ground plate(s) 206a, 206b is disconnected.

The portable radio further comprises a side locking arm 120 for securing the battery 200 to the portable radio 100.

FIG. 3 shows different views of the rotational attachment of the battery 200 relative to the portable radio 100 having the battery interface formed in accordance with some embodiments. The views 310, 320, 330 may also refer back to other figures. FIG. 3 further includes a partial cross-sectional side view 312 of the portable radio (without battery) and a partial cross-sectional view 332 with battery secured to the portable radio.

View 310 shows the portable radio 100 having the assembled battery interface 102 on the bottom surface of the portable radio housing 101 along a longitudinal axis (x, x′). The battery lock plate 104 includes the first and second side tabs 104d, 104e extending therefrom. The first finger spring contact 108d is shown in this view with first raised portion 108h of the ground contact spring plate 108 being shown in other views. Although not shown in FIG. 3, it is understood that the second finger spring contact 108e with second raised portion 108i of the ground contact spring plate 108 is located diagonally opposite. The first and second raised portions 108h, 108i provide opposed ramps on the ground contact spring plate 108.

View 310 further shows the battery 200 having the radio interface 202 (shown in FIG. 1) located on the battery's top surface. Charging contacts 208 are located on the bottom surface of the battery 200.

To couple the battery 200 to the portable radio 100, the radio interface 102 of the top surface of the battery is brought towards the bottom surface of the portable radio 100 at an approximate 45 degree offset relative to the longitudinal axis (x, x′).

View 320 shows the top surface of the battery 200 seated upon the battery interface 102 of the portable radio 100, offset by approximately 45 degrees relative to the x-x′ axis. Although not seen in this view, (and briefly referring back to the elements of FIG. 1) the planar contacts 204 (B+, data, B+) disposed on the top surface of the battery 200 are recessed between the first and second ground plates 206a, 206b. The bottom surface of first and second battery ground plates 206a, 206b begin engagement to the lower lock plate surface 104b of the battery lock plate 104. The battery 200 correctly couples to the radio 100 using two half round tabs 314 of the battery lock plate 104.

The battery 200 is then rotated/twisted clockwise (or 45 degrees to zero degrees). The rotation causes the first and second battery ground plates 206a, 206b to rotate into the respective first and second gaps 108j, 108k formed between the first and second raised portions 108j, 108k of respective first and second finger spring contacts 108d, 108e. The rotation causes a cam action which compressibly couples each battery ground plate 206a, 206b against the respective tapered surfaces of the first and second side tabs 104d, 104e of the lower lock plate surface 104b (filling the predetermined gaps). The rotation continues until the top of the battery 200 aligns with the longitudinal axis of the bottom surface of the portable radio 100.

View 330 shows the battery 200 completely secured to the portable radio 100. The assembled battery interface 102 sits between the first guide rail 118a (shown in FIG. 2) and second guide rail 118b. The second raised alignment tab 118d aligns and abuts with the second side tab 104e extending from the battery lock plate 104 shown in FIG. 1. Similarly, (although not shown) the first raised alignment tab 118c aligns and abuts with the first side tab 104d extending from the battery lock plate 104. In view 330, the side locking arm 120 of the portable radio 100 further secures the portable radio 100 to the battery 200.

In view 330, and as previously stated, the primary ground contact is established by the connection between the bottom surface (lower lock plate surface 104b) of the battery lock plate 104 of the portable radio 100 and the bottom surface(s) of the first and second battery ground plates 206a, 206b on the battery 200. However, the battery ground plate(s) 206a, 206b are mounted on the plastic body of the battery 200, which may cause the first and second battery ground plate(s) 206a, 206b to move during high impact situations, resulting in intermittent disconnection of the battery lock plate 104.

As previously stated and in accordance with the embodiments, the first and second raised portions 108h, 108i of the first and second finger spring contacts 108d, 108e are compressed against the top surfaces of the first and second battery ground plates 206a, 206b (when the battery is attached to the radio). The first and second finger spring contacts 108d, 108e will accommodate vertical movement of the first and second battery ground plate(s) 206a, 206b under high impact scenarios. The first and second raised portion(s) 108h, 108i of the of the first and second finger spring contact(s) 108d, 108e flex to maintain contact with the first and second battery ground plates 206a, 206b, thereby ensuring that ground contact is maintained even when the primary contact between the battery lock plate 104 and the first and second battery ground plate(s) 206a, 206b is disconnected.

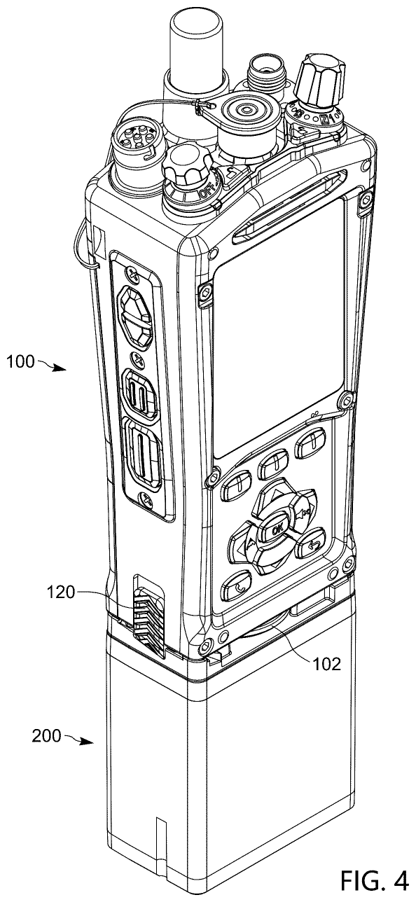

FIG. 4 illustrates the portable radio 100 with battery 200 fully attached, in accordance with some embodiments. The portable radio 100 includes the battery interface 102 formed in accordance with the embodiment. The battery interface 102 as previously described, advantageously includes the ground contact spring plate 108 (shown in FIG. 2) that provides additional protection against intermittent ground during drop and vibration.

The portable radio 100 may be a military tactical radio which operate over VHF, such as VHF Low Band and High Band frequencies. The portable radio may be configured to operate over other frequencies, such as UHF and 700/800 MHz frequencies which may be more suitable to first responder operations, such as law enforcement, fire rescue, and the like.

The portable radio's battery interface 102, formed in accordance with previously described embodiments, advantageously accepts off the shelf batteries available from multiple manufacturers. An example of such a battery is the MBITR PRC-148 battery available from Brentronics, Inc. As previously noted, these off-the shelf batteries as well as similar batteries from other manufacturers, tend to exhibit a general weakness of intermittent ground (GND) when coupled to a radio that is subjected to drop and/or vibration, particularly under harsh environments encountered by military tactical radios. The portable radio's battery interface 102 including ground spring contact plate 108 provides the additional robustness and reliability that prevents intermittent ground conditions from occurring during drop and vibration. The ground spring contact plate 108 is tactically hidden and protected under the battery lock plate 104. The design of the ground spring contact plate 108 may be fully integrated into current battery interface assembly stack-ups without impeding the twist to lock action. Additionally, as the ground spring contact plate 108 makes contact with the battery ground plates during twist and lock, the ground spring contact plate 108 wipes away any contamination, thereby ensuring proper contact.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A ground contact spring plate for a battery interface of a portable radio, comprising;
a unitary sheet metal piece part having a top surface and a bottom surface;
a center aperture formed through the top surface and bottom surface;
first and second finger spring contacts integrally formed along first and second side edges of the ground contact spring plate.

2. The ground contact spring plate of claim 1, wherein the unitary sheet metal piece part is rectangular in shape.

3. The ground contact spring plate of claim 1, wherein the first finger spring contact has a first raised portion relative to the top surface, and the second finger spring contact has a second raised portion relative to the top surface, the first raised portion and the second raised portion being diagonally opposite to each other.

4. The ground contact spring plate of claim 1, wherein the unitary sheet metal piece part further comprises:
first and second screw holes formed through the top and bottom surfaces, the first screw hole being located between the aperture and the first finger spring contact, and the second screw hole being formed between the aperture and the second finger spring contact.

5. The ground contact spring plate of claim 1, wherein the unitary sheet metal piece part has a planar thickness ranging between 0.12 millimeters and 0.18 millimeters, and the first and second finger spring contacts integrally formed along the first and second side edges each have first and second raised portions, the first and second raised portions being diagonally opposite each other and the first and second raised portions each having a height ranging between 2.1 millimeters and 2.5 millimeters relative to the bottom surface of the unitary sheet metal piece part.

6. An assembly for a battery interface of a portable radio, the assembly comprising:
a battery lock plate having upper and lower lock plate surfaces with an aperture formed therethrough and first and second side tabs extending therefrom, the first and second side tabs having respective first and second tapered surfaces on the lower lock plate surface;
a battery connector having top and bottom surfaces, the top surface of the battery connector having pogo pins which extend within the aperture of the battery lock plate, the bottom surface of the battery connector having tail ends of the pogo pins extending therefrom;
a ground contact spring plate having an aperture through which the tail ends of the pogo pins of the battery connector extend, the ground contact spring plate having first and second finger spring contacts formed at first and second side edges of the ground contact spring plate, the first and second finger spring contacts having respective first and second raised portions, the first and second raised portions respectively providing first and second predetermined gaps with the first and second tapered surfaces of the first and second side tabs, the first and second predetermined gaps for receiving first and second battery ground plates of a battery.

7. The assembly of claim 6, wherein the first and second raised portions of the first and second spring contacts form respective first and second predetermined gaps with the first and second tapered surfaces of the first and second side tabs of the battery lock plate.

8. The assembly of claim 6, wherein when the battery is attached to the portable radio, a primary ground contact is established by connection between the lower lock plate surface on the portable radio and the bottom surface of the first and second battery ground plates on the battery, the first and second raised portions of the first and second finger spring contacts are compressed against a top surface of the first and second battery ground plates, the first and second finger spring contacts accommodating vertical movement of the first and second battery ground plates under high impact conditions, wherein the first and second raised portions of the first and second finger spring contacts flex to maintain contact with the first and second battery ground plates thereby ensuring that a ground contact is maintained even under conditions in which the primary ground contact between the battery lock plate of the portable radio and the first and second battery ground plates of the battery is disconnected.

9. The assembly of claim 6, wherein the assembly for the battery interface couples between first and second guide rails located on the bottom surface of the portable radio.

10. The assembly of claim 6, wherein the first and second finger spring contacts of the ground contact spring plate engage and push first and second ground plates of the battery against the first and second side tabs at the lower lock plate surface of the battery lock plate.

11. The assembly of claim 6, wherein the tail ends of the pogo pins are coupled, via a flex, to corresponding power contacts on a printed circuit board (PCB) recessed within a circular opening of the portable radio.

12. The assembly of claim 11, wherein an electronic flex couples the tail ends of the pogo pins to the corresponding power contacts on the PCB.

13. A portable radio, comprising:
a radio housing having a battery interface, the battery interface comprising:
a battery lock plate having an upper and lower lock plate surface with an aperture formed therethrough and first and second side tabs extending therefrom, the first and second side tabs having first and second tapered surfaces on the lower lock plate surface;
a battery connector having top and bottom surfaces, the top surface having pogo pins extending therefrom, the pogo pins extending into the aperture of the battery lock plate, the bottom surface of the battery connector having tail ends of the pogo pins extending therefrom;
a ground contact spring plate having an aperture through which the tail ends of the pogo pins extend, the ground contact spring plate having first and second finger spring contacts integrally formed and located at first and second side edges of the ground contact spring plate, the first and second finger spring contacts having respective first and second raised portions, the first and second finger spring contacts respectively align beneath the first and second side tabs of the battery lock plate with a predetermined gap formed therebetween;
a battery coupled to the battery interface of the portable radio, the battery comprising:
a battery housing having radio interface upon which are disposed planar contacts situated between first and second battery ground plates, the planar contacts of the battery align and mate with the pogo pins that extend from the battery connector through the aperture of the battery lock plate of the portable radio; and
wherein the first and second raised portions of the first and second finger spring contacts respectively push the first and second battery ground plates against the first and second tapered surfaces of the first and second side tabs of the lower lock plate surface.

14. The portable radio of claim 13, wherein the ground contact spring plate is a unitary sheet metal piece part, wherein the first and second finger spring contacts are integrally formed along first and second side edges of the unitary sheet metal piece part.

15. The portable radio of claim 13, wherein the first and second battery ground plates are compressibly coupled to the first and second tapered surfaces of the first and second side tabs of the lower lock plate surface via a cam action which applies a rotational twist to the first and second battery ground plates along the first and second tapered surfaces of the first and second side tabs of the lower lock plate surface.

16. The portable radio of claim 13, wherein the battery is coupled to the battery interface of the portable radio via a rotational twist which aligns and compressibly couples the first and second battery ground plates of the battery between the first and second finger spring contacts and the first and second side tabs of the battery lock plate.

17. The portable radio of claim 13, wherein the portable radio is a VHF radio.

18. The portable radio of claim 13, wherein the battery lock plate, battery connector, and ground contact spring plate are coupled via first and second screws to a paint-free zone of the portable radio.

19. The portable radio of claim 13, wherein the tail ends of the pogo pins are coupled, via an electronic flex, to corresponding power contacts disposed on a PCB recessed within a circular opening of the portable radio

20. The portable radio of claim 13, wherein the radio housing further comprises:
a side locking arm for securing the battery to the bottom surface of the portable radio.

21. The portable radio of claim 13, further comprising:
a first guide rail with a first raised alignment tab located on a bottom surface of the portable radio;
a second guide rail with a second raised alignment tab located on the bottom surface of the portable radio;
a circular opening located between the first and second guide rails, the circular opening leading to a recessed printed circuit board (PCB) having power contacts disposed thereon; and
the battery interface is situated between the first guide rail and second guide rail, wherein the first raised alignment tab aligns and abuts with the first side tab extending from the battery lock plate, and the second raised alignment tab aligns and abuts with the second side tab extending from the battery lock plate.
